(19) United States
(12) Patent Application Publication
(10) Pub. No.: US 2025/0106687 A1
(43) Pub. Date: Mar. 27, 2025

(54) SYSTEMS AND METHODS FOR MANAGING CAPACITY OF A FIXED WIRELESS ACCESS BROADBAND NETWORK

(71) Applicant: Verizon Patent and Licensing Inc., Basking Ridge, NJ (US)

(72) Inventors: Abhitabh KUSHWAHA, Tampa, FL (US); Michael C. ZARBO, Blackstone, MA (US); Christine D. BARGER, Marysville, PA (US); Rajender R. NEDNUR, Alpharetta, GA (US)

(73) Assignee: Verizon Patent and Licensing Inc., Basking Ridge, NJ (US)

(21) Appl. No.: 18/475,562

(22) Filed: Sep. 27, 2023

(51) Int. Cl. H04W 28/086; H04W 24/02

(52) U.S. Cl. CPC H04W 28/0861; H04W 24/02

(57) ABSTRACT

A device may receive, before a time period, current capacity data associated with sectors of an FWA network and qualified sector data identifying qualified sectors of FWA devices associated with the FWA network, and may receive, over the time period, FWA data associated with the FWA devices and corresponding sectors. The device may apply rules to the FWA data to generate modified FWA data, and may calculate maximum data volumes during the time period for the FWA devices based on the modified FWA data. The device may assign actual sectors to the FWA devices based on the maximum data volumes, and may compare the qualified sectors and the actual sectors to identify modified sectors. The device may modify the current capacity data based on the modified sectors and to generate modified capacity data associated with the sectors, and may perform actions based on the modified capacity data.

### BACKGROUND

Fixed wireless access (FWA) uses fourth generation (4G) and fifth generation (5G) radio spectrum to provide wireless broadband connectivity between two fixed points (e.g., between a network base station and an FWA device in a customer's home). FWA uses radio waves to send high-speed signals that offer data transfer to and from consumer devices (e.g., user equipment). An FWA system may include a base station connected to a core network and to a quantity of FWA devices (e.g., customer premises equipment (CPE)) spread over a wide area. The base station uses radio waves to communicate with the FWA devices, making it possible for consumers to connect to the core network and access high-speed data services.

### BRIEF DESCRIPTION OF THE DRAWINGS

FIGS. 1A-1G are diagrams of an example associated with managing capacity of an FWA broadband network.

FIG. 2 is a diagram of an example environment in which systems and/or methods described herein may be implemented.

FIG. 3 is a diagram of example components of one or more devices of FIG. 2.

FIG. 4 is a flowchart of an example process for managing capacity of an FWA broadband network.

### DETAILED DESCRIPTION OF EXAMPLE EMBODIMENTS

The following detailed description of example implementations refers to the accompanying drawings. The same reference numbers in different drawings may identify the same or similar elements.

Capacity planning for new FWA subscribers is based on counts of existing FWA subscribers. If the counts of existing FWA subscribers is inaccurate, then adding new FWA subscribers to an oversubscribed FWA sector may lead to overcapacity for the FWA sector. A current method of tracking which sector an FWA device is using is based on a sector through which the FWA device is qualified for use. However, network conditions, such as network densification, carrier additions, site modifications, terrain, foliage, being located at a sector edge, and/or the like may cause the connectivity of some FWA devices to bounce between two or more neighboring sectors. In some cases, a sector may provide bleeding edge coverage for an FWA device (e.g., far from an intended footprint) which may impede the qualified sector of the FWA device from continuing to be a preferred sector for the FWA device. This results in determining incorrect sectors for new FWA devices based on the reported available capacity. For example, an FWA device may connect with a sector that is close to or completely out of capacity, which may cause the FWA device and/or mobile devices connected to the sector to have a poor user experience. In another example, the FWA device may connect with a less loaded sector, which may increase capacity on the qualified sector of the FWA device.

Thus, current techniques for managing capacity of an FWA broadband network consume computing resources (e.g., processing resources, memory resources, communication resources, and/or the like), networking resources, and/or other resources associated with incorrectly determining capacities of sectors of an FWA broadband network, disrupting communications for an FWA device during times of congestion, causing a poor user experience for a user of an FWA device due to disrupting the communications for the FWA device, delaying the communications for the FWA device during times of congestion, and/or the like.

Some implementations described herein provide a capacity management system that manages capacity of an FWA broadband network. For example, the capacity management system may receive, before a time period, current capacity data associated with sectors of an FWA network and qualified sector data identifying qualified sectors of FWA devices associated with the FWA network, and may receive, over the time period, FWA data associated with the FWA devices and corresponding sectors. The capacity management system may apply rules to the FWA data to generate modified FWA data, and may calculate maximum data volumes during the time period for the FWA devices based on the modified FWA data. The capacity management system may assign actual sectors to the FWA devices based on the maximum data volumes, and may compare the qualified sectors and the actual sectors to identify modified sectors. The capacity management system may modify the current capacity data based on the modified sectors and to generate modified capacity data associated with the sectors, and may perform actions based on the modified capacity data.

In this way, the capacity management system manages capacity of an FWA broadband network. For example, the capacity management system may enable more accurate capacity calculations for an FWA broadband network. The capacity management system may provide a near-real-time view (e.g., based on a quantity of days of data, such as thirty or more days) of sectors in which FWA devices are utilizing a majority of data when such sectors are different from the qualified sectors for the FWA devices. The capacity management system may determine which sectors the FWA devices utilize for a majority of a time period (e.g., thirty days, forty days, and/or the like). If the determined sectors match the qualified sectors for the FWA devices, the capacity management system may not modify the available capacity of the determined sectors. However, if the determined sectors fail to match the qualified sectors for the FWA devices, the capacity management system may modify the available capacity of the determined sectors. Thus, the capacity management system may conserve computing resources, networking resources, and/or other resources that would have otherwise been consumed by incorrectly determining capacities of sectors of an FWA broadband network, disrupting communications for an FWA device during times of congestion, causing a poor user experience for a user of an FWA device due to disrupting the communications for the FWA device, delaying the communications for the FWA device during times of congestion, and/or the like.

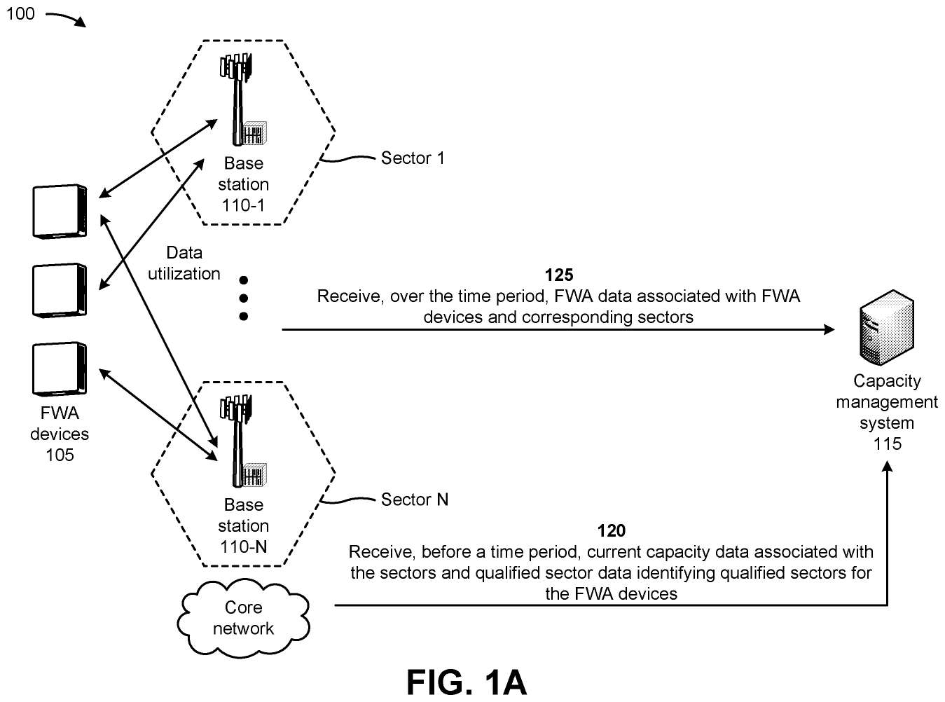

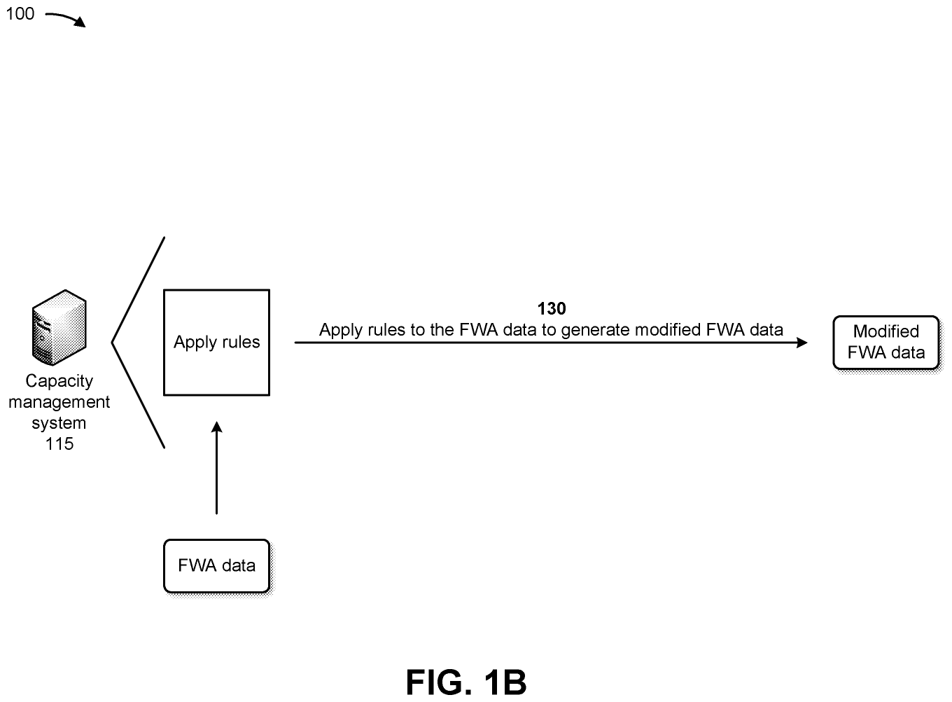

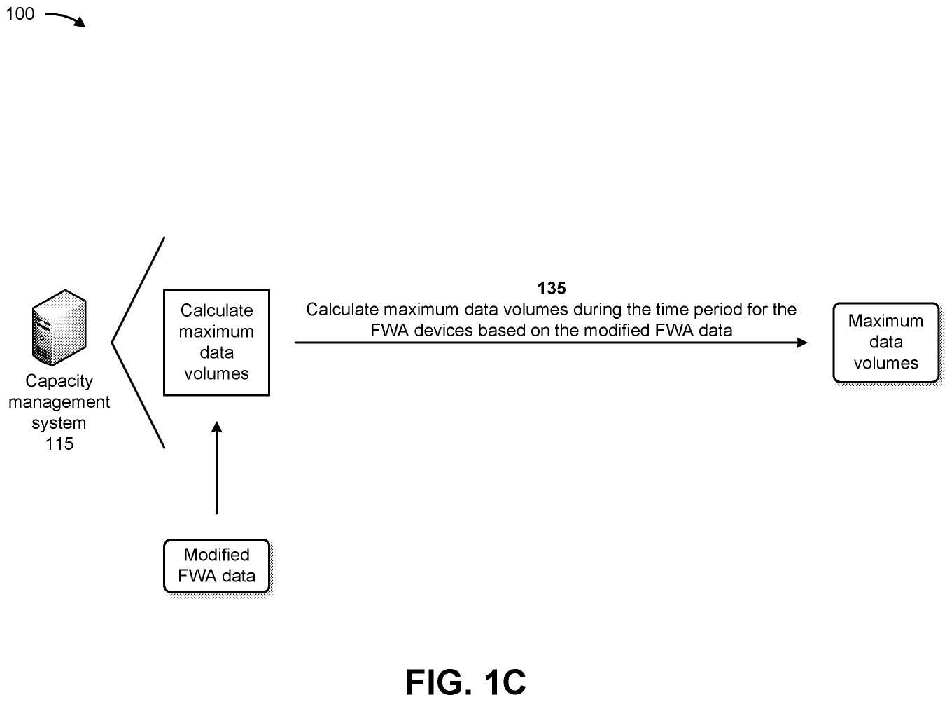

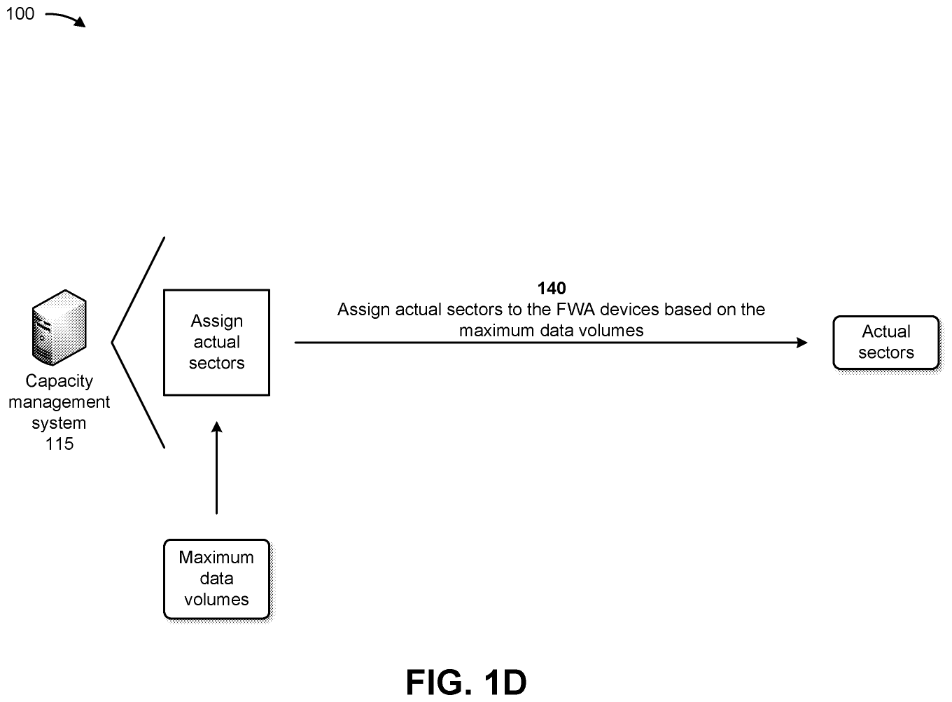

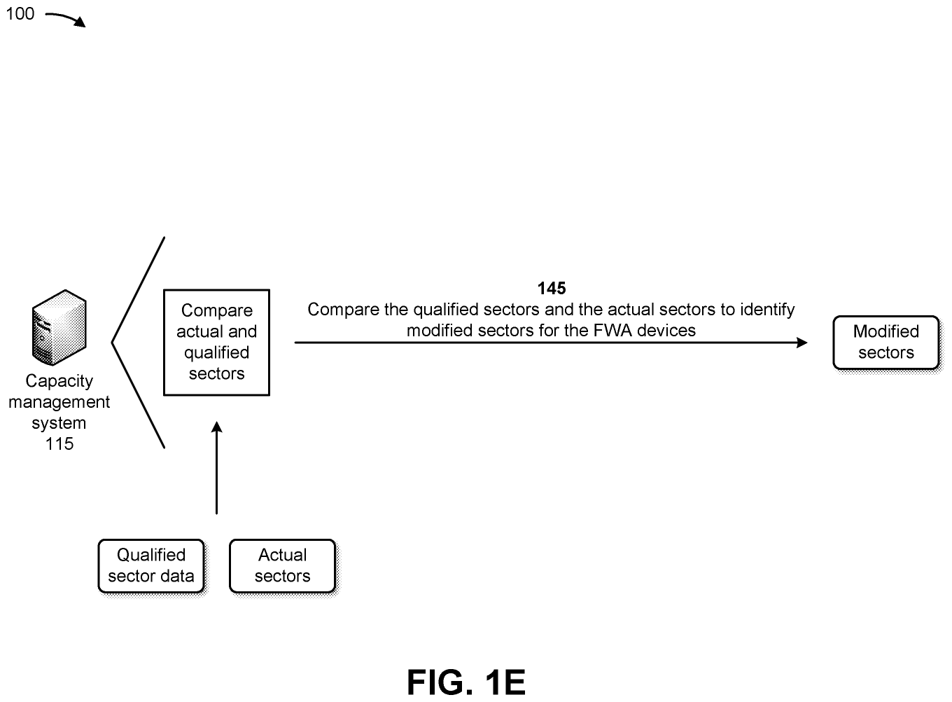

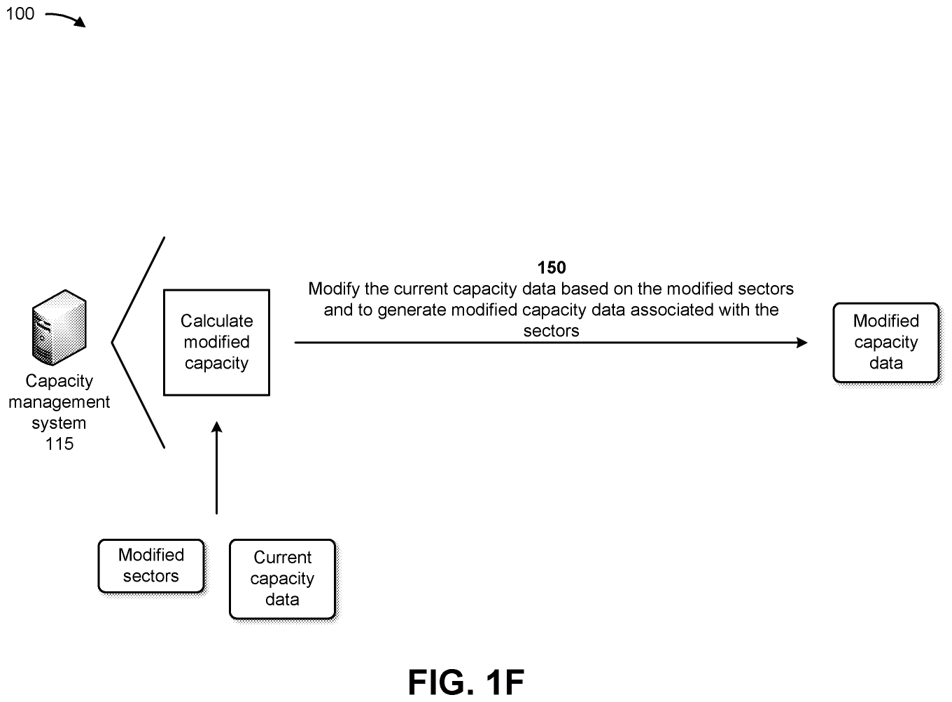

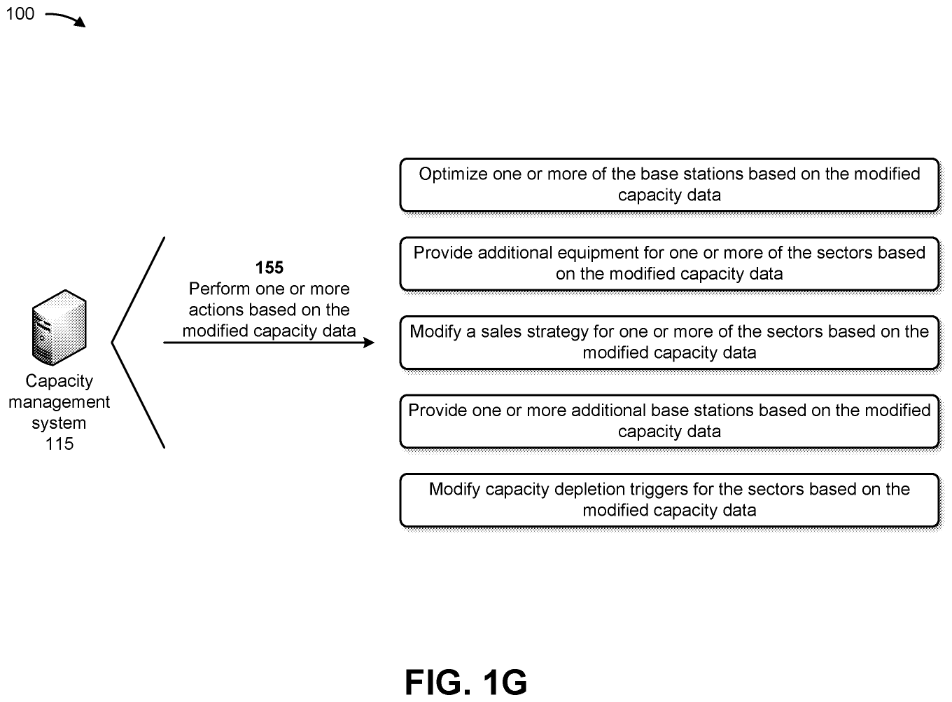

FIGS. 1A-1G are diagrams of an example 100 associated with managing capacity of an FWA broadband network. As shown in FIGS. 1A-1G, example 100 includes FWA devices 105 (e.g., a customer premises equipment (CPE)) associated with a plurality of base stations 110-1 through 110-N (e.g., referred to herein individually as a base station 110 or plurally as base stations 110) that provide corresponding sectors (e.g., sector 1 through sector N). Example 100 also includes a capacity management system 115 and a core network associated with the base stations 110-1 through 110-N. Further details of the FWA devices 105, the base stations 110, the sectors, the capacity management system 115, and the core network are provided elsewhere herein.

As shown in FIG. 1A, the FWA devices 105 may connect to and utilize data from one or more of the base stations 110 (e.g., one or more of the sectors provided by the one or more base stations 110). For example, each of the FWA devices 105 may be qualified with a sector located closest to the FWA device 105, and the core network may capture qualified sector data identifying the qualified sectors for the FWA devices 105. However, network conditions, such as network densification, carrier additions, site modifications, terrain, foliage, being located at a sector edge, and/or the like may cause some FWA devices 105 to bounce between two or more neighboring sectors (for example, and connect to and utilize data from the two or more neighboring sectors. In some cases, a sector may provide bleeding edge coverage for an FWA device 105 (e.g., far from a qualified sector of the FWA device 105) which may impede the qualified sector of the FWA device 105 from continuing to be a preferred sector for the FWA device 105. The base stations 110 may capture current capacity data associated with the sectors (e.g., identifying available capacity of the sectors). The base stations 110 may capture the data utilization by the FWA devices 105 as FWA data associated with the FWA devices 105.

As further shown in FIG. 1A, and by reference number 120, the capacity management system 115 may receive, before a time period, current capacity data associated with the sectors and qualified sector data identifying qualified sectors for the FWA devices 105. For example, the capacity management system 115 may set a time period for collecting data associated with the FWA devices 105 and capacity of the sectors provided by the base stations. In some implements, the time period may last at least thirty days, forty days, fifty days, and/or the like. Before the time period begins, the capacity management system 115 may receive the current capacity data associated with the sectors from the base stations 110. In some implementations, the base stations 110 may automatically provide the current capacity data associated with the sectors to the capacity management system 115. Alternatively, the capacity management system 115 may request the current capacity data associated with the sectors from the base stations 110 and may receive the current capacity data based on the request.

Before the time period begins, the capacity management system 115 may receive the qualified sector data identifying the qualified sectors for the FWA devices 105 from the core network or the base stations 110. In some implementations, the core network or the base stations 110 may automatically provide the qualified sector data identifying the qualified sectors for the FWA devices 105 to the capacity management system 115. Alternatively, the capacity management system 115 may request the qualified sector data identifying the qualified sectors for the FWA devices 105 from the core network or the base stations 110 and may receive the qualified sector data based on the request.

As further shown in FIG. 1A, and by reference number 125, the capacity management system 115 may receive, over the time period, FWA data associated with the FWA devices 105 and corresponding sectors. For example, the base stations 110 may capture, over the time period, the FWA data associated with the data utilization by the FWA devices 105 from the corresponding sectors. The base stations 110 may continuously provide the FWA data associated with the FWA devices 105 and the corresponding sectors to the capacity management system 115 over the time period, and the capacity management system 115 may continuously receive the FWA data associated with the FWA devices 105 and the corresponding sectors. In some implementations, the base stations 110 may periodically provide the FWA data associated with the FWA devices 105 and the corresponding sectors to the capacity management system 115 over the time period, and the capacity management system 115 may periodically receive the FWA data associated with the FWA devices 105 and the corresponding sectors.

As shown in FIG. 1B, and by reference number 130, the capacity management system 115 may apply rules to the FWA data to generate modified FWA data. For example, the capacity management system 115 may apply one or more rules to the FWA data to generate the modified FWA data. In some implementations, when applying the one or more rules to the FWA data to generate the modified FWA data, the capacity management system may apply one or more exclusion rules that exclude data from the FWA data, may apply a rule that combines the FWA data for each of the sectors, may apply one or more network rules that modify a current capacity associated with the FWA data, and/or the like. The one or more exclusion rules may include a rule that excludes any FWA device 105 that has not been a customer for at least the time period (e.g., is new to the network), a rule that excludes any FWA device 105 that is greater than a predetermined distance (e.g., in meters, kilometers, or the like) from a home location, a rule that excludes any FWA device 105 that utilizes fourth generation (4G) technology, a rule that excludes any FWA device 105 that produces FWA data for less than half of the time period, and/or the like.

The rule that combines the FWA data for each of the sectors may include analyzing twenty-four hours of FWA data for each FWA device 105 for each day, and assigning a sector with the greatest FWA data daily volume to the FWA device 105 for each day. This process may be repeated for the time period (e.g., thirty or more days) so that each FWA device 105 is associated with a predetermined quantity of (e.g., thirty) FWA data points. The one or more network rules may include a rule that recalculates a sector's maximum capacity if new equipment is added to the sector during the time period, a rule that sets a maximum capacity for a new sector added during the time period, and/or the like. In some implementations, the maximum capacity may be based on a spectrum of the base station 110 utilized to generate a new sector (e.g., a maximum capacity of ten, twenty, thirty, and/or the like FWA devices 105).

As shown in FIG. 1C, and by reference number 135, the capacity management system 115 may calculate maximum data volumes during the time period for the FWA devices 105 based on the modified FWA data. For example, for each of the sectors to which an FWA device 105 connects over the time period, the capacity management system 115 may calculate a forward data volume (FDV) (e.g., Sector 1 FDV, Sector 2 FDV, Sector 3 FDV, . . . , Sector N FDV). The capacity management system 115 may calculate a maximum data volume for the FWA device 105, based on the modified FWA data, as follows:

MAX[(Sector 1 FDV),(Sector 2 FDV),(Sector 3 FDV), . . . ,(Sector N FDV)].

The capacity management system 115 may repeat this process for all of the FWA devices 105 to calculate the maximum data volumes during the time period for the FWA devices 105 based on the modified FWA data.

As shown in FIG. 1D, and by reference number 140, the capacity management system 115 may assign actual sectors to the FWA devices 105 based on the maximum data volumes. For example, the sectors associated with the maximum data volumes may be the sectors in which the FWA devices 105 utilized the most data compared to other sectors. Thus, the sectors associated with the maximum data volumes may be the actual sectors utilized by the FWA devices 105 and may be same as or different from the qualified sectors for the FWA devices 105. The capacity management system 115 may assign the sectors associated with the maximum data volumes to the FWA devices 105 and may designate such sectors as the actual sectors for the FWA devices 105.

As shown in FIG. 1E, and by reference number 145, the capacity management system 115 may compare the qualified sectors and the actual sectors to identify modified sectors for the FWA devices 105. For example, the capacity management system 115 may compare the qualified sectors for the FWA devices 105 and the actual sectors for the FWA devices 105 to determine whether the qualified sectors for the FWA devices 105 and the actual sectors for the FWA devices 105 differ. In some implementations, when comparing the qualified sectors and the actual sectors to identify the modified sectors for the FWA devices 105, the capacity management system 115 may determine that one of the qualified sectors fails to match a corresponding one of the actual sectors, and may identify, as one of the modified sectors, the corresponding one of the actual sectors instead of the one of the qualified sectors. In some implementations, when comparing the qualified sectors and the actual sectors to identify the modified sectors for the FWA devices 105, the capacity management system 115 may determine that one of the qualified sectors matches a corresponding one of the actual sectors, and may maintain, as one of the modified sectors, the one of the qualified sectors. For example, if an actual sector of an FWA device 105 matches a qualified sector of the FWA device 105, the modified sectors may include the qualified sector. If an actual sector of an FWA device 105 fails to match a qualified sector of the FWA device 105, the modified sectors may include the actual sector (e.g., one capacity slot (e.g., for hosting an FWA device 105) may be removed from the actual sector and one capacity slot may be added to the qualified sector).

As shown in FIG. 1F, and by reference number 150, the capacity management system 115 may modify the current capacity data based on the modified sectors and to generate modified capacity data associated with the sectors. For example, the modified sectors may cause capacity slots (e.g., for hosting FWA devices 105) to be modified compared to the capacity slots associated with the current capacity data. As described above, a capacity slot (e.g., for hosting an FWA device 105) may be removed from an actual sector and one capacity slot may be added to a qualified sector. Thus, the capacity management system 115 may modify the current capacity data based on the modified sectors and to generate the modified capacity data associated with the sectors (e.g., identifying modified available capacity of the sectors). In some implementations, the modified capacity data may indicate that a sector includes one or more additional capacity slots than indicated by the current capacity data, the modified capacity data may indicate that a sector includes one or more fewer capacity slots than indicated by the current capacity data, the modified capacity data may indicate that a sector has the same capacity slots as indicated by the current capacity data, and/or the like. In some implementations, the modified capacity data identifies available capacities of the sectors after the time period.

As shown in FIG. 1G, and by reference number 155, the capacity management system may perform one or more actions based on the modified capacity data. In some implementations, when performing the one or more actions, the capacity management system 115 may optimize one or more of the base stations 110 based on the modified capacity data. For example, the modified capacity data may indicate that one or more base stations 110 need to be optimized to handle the FWA devices 105 and to lessen overburdened sectors. The capacity management system 115 may cause the one or more base stations 110 to be optimized. For example, when causing the one or more base stations 110 to be optimized based on the modified capacity data, the capacity management system 115 may cause tilts of the one or more base stations 110 to be modified based on the modified capacity data, may cause azimuths of the one or more base stations 110 to be modified based on the modified capacity data, or may cause additional spectrum to be added to the one or more base stations 110 based on the modified capacity data. In this way, the capacity management system 115 may conserve computing resources, networking resources, and/or other resources that would have otherwise been consumed by incorrectly determining capacities of sectors of an FWA broadband network.

In some implementations, when performing the one or more actions, the capacity management system 115 may provide additional equipment for one or more of the sectors based on the modified capacity data. For example, the modified capacity data may indicate that one or more sectors are overburdened. The capacity management system 115 may determine that the one or more sectors may benefit from additional equipment (e.g., another base station 110, more powerful components for a base station 110, and/or the like). The capacity management system 115 may cause the additional equipment to be implemented for the one or more sectors so that the one or more sectors may handle capacity requirements of the FWA devices 105 and not be overburdened. In this way, the capacity management system 115 may conserve computing resources, networking resources, and/or other resources that would have otherwise been consumed by disrupting communications for an FWA device 105 during times of congestion.

In some implementations, when performing the one or more actions, the capacity management system 115 may modify a strategy for allocating one or more of the sectors based on the modified capacity data. For example, the modified capacity data may indicate that one or more sectors are at capacity and cannot handle any more FWA devices 105. The capacity management system 115 may cause a sales strategy for the one or more sectors to be modified so that no capacity slots of the one or more sectors are offered for sale for FWA devices 105. The modified capacity data may indicate that other sectors are below capacity and can handle more FWA devices 105. The capacity management system 115 may cause a sales strategy for the other sectors to be modified so that more capacity slots of the other sectors are offered for sale for FWA devices 105. In this way, the capacity management system 115 may conserve computing resources, networking resources, and/or other resources that would have otherwise been consumed by causing a poor user experience for a user of an FWA device 105 due to disrupting the communications for the FWA device 105.

In some implementations, when performing the one or more actions, the capacity management system 115 may provide one or more additional base stations 110 based on the modified capacity data. For example, the modified capacity data may indicate that one or more sectors are overburdened. The capacity management system 115 may determine that the one or more sectors may benefit from one or more additional base stations 110. The capacity management system 115 may cause the one or more additional base stations 110 to be implemented for the one or more sectors so that the one or more sectors may handle capacity requirements of the FWA devices 105 and not be overburdened. In this way, the capacity management system 115 may conserve computing resources, networking resources, and/or other resources that would have otherwise been consumed by delaying the communications for the FWA device 105 during times of congestion.

In some implementations, when performing the one or more actions, the capacity management system 115 may modify capacity depletion triggers for the sectors based on the modified capacity data. For example, the sectors may be associated with capacity depletion triggers that indicate when a sector is nearing capacity depletion. If the modified capacity data indicates that sector is nearing capacity depletion sooner than indicated by the capacity depletion trigger, the sector may be depleted of capacity if the capacity depletion trigger is utilized. The capacity management system 115 may modify the capacity depletion trigger so that the capacity depletion trigger matches the capacity depletion date identified by the modified capacity data. In this way, the capacity management system 115 may conserve computing resources, networking resources, and/or other resources that would have otherwise been consumed by incorrectly determining capacities of sectors of an FWA broadband network.

In this way, the capacity management system 115 manages capacity of an FWA broadband network. For example, the capacity management system 115 may enable more accurate capacity calculations for an FWA broadband network. The capacity management system 115 may provide a near-real time view of sectors in which FWA devices 105 are utilizing a majority of data when such sectors are different from the qualified sectors for the FWA devices 105. The capacity management system 115 may determine which sectors the FWA devices 105 utilize for more than half of a time period (e.g., thirty days, forty days, and/or the like). If the determined sectors match the qualified sectors for the FWA devices 105, the capacity management system 115 may not modify the available capacity of the determined sectors. However, if the determined sectors fail to match the qualified sectors for the FWA devices 105, the capacity management system 115 may modify the available capacity of the determined sectors. Thus, the capacity management system 115 may conserve computing resources, networking resources, and/or other resources that would have otherwise been consumed by incorrectly determining capacities of sectors of an FWA broadband network, disrupting communications for an FWA device 105 during times of congestion, causing a poor user experience for a user of an FWA device 105 due to disrupting the communications for the FWA device 105, delaying the communications for the FWA device 105 during times of congestion, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

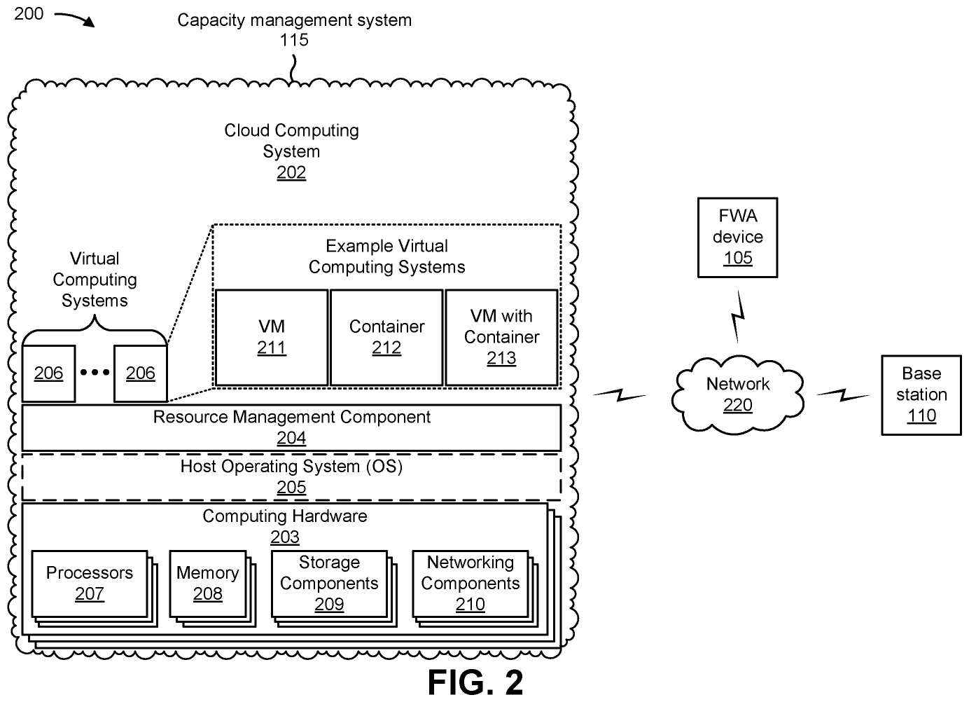

FIG. 2 is a diagram of an example environment 200 in which systems and/or methods described herein may be implemented. As shown in FIG. 2, the environment 200 may include the capacity management system 115, which may include one or more elements of and/or may execute within a cloud computing system 202. The cloud computing system 202 may include one or more elements 203-213, as described in more detail below. As further shown in FIG. 2, the environment 200 may include the FWA device 105, the base station 110, and/or a network 220. Devices and/or elements of the environment 200 may interconnect via wired connections and/or wireless connections.

The FWA device 105 includes one or more devices capable of receiving, generating, storing, processing, and/or providing information, such as information described herein. For example, the FWA device 105 may include a mobile hotspot device, an FWA device, a customer premises equipment (CPE), an FWA channel service unit, an FWA data service unit, an FWA router, an FWA wireless access point (WAP) device, an FWA modem, an FWA set-top box, or a similar type of device. The FWA device 105 may provide wireless connectivity through radio links between two fixed points. In other words, the FWA device 105 may provide wireless Internet access to homes or businesses without laying fiber and cables to provide last mile connectivity.

The base station 110 includes one or more devices capable of transferring traffic, such as audio, video, text, and/or other traffic, destined for and/or received from a user equipment. For example, the base station 110 may include an eNodeB (eNB) associated with a long term evolution (LTE) network that receives traffic from and/or sends traffic to a core network, a gNodeB (gNB) associated with a RAN of a 5G network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 110 may support, for example, a cellular radio access technology (RAT). The base station 110 may transfer traffic between a user equipment (e.g., using a cellular RAT), one or more other base stations 110 (e.g., using a wireless interface or a backhaul interface, such as a wired backhaul interface), and/or a core network. The base station 110 may provide one or more cells that cover geographic areas.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

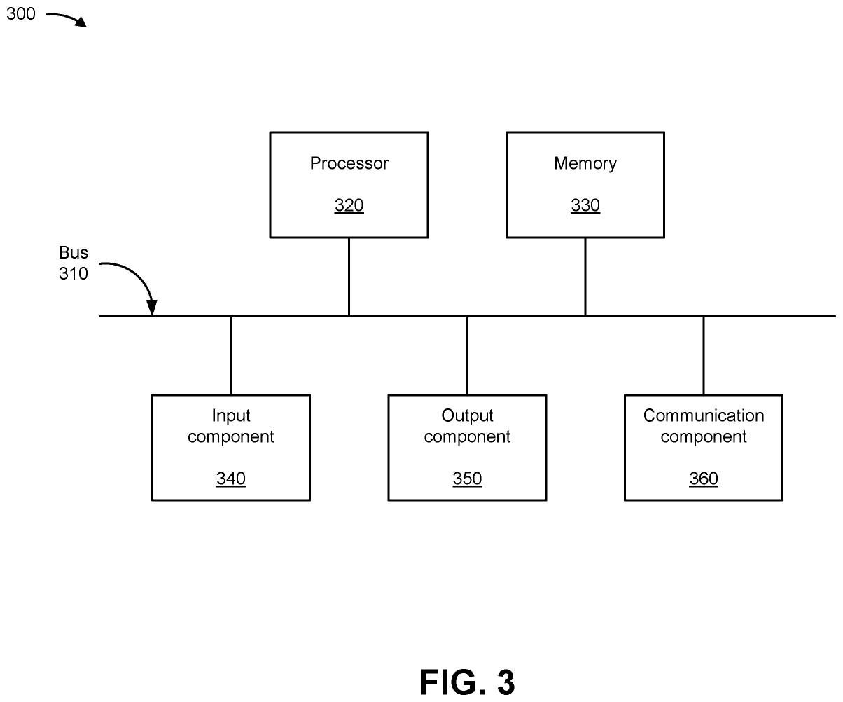

Although the capacity management system 115 may include one or more elements 203-213 of the cloud computing system 202, may execute within the cloud computing system 202, and/or may be hosted within the cloud computing system 202, in some implementations, the capacity management system 115 may not be cloud-based (e.g., may be implemented outside of a cloud computing system) or may be partially cloud-based. For example, the capacity management system 115 may include one or more devices that are not part of the cloud computing system 202, such as the device 300 of FIG. 3, which may include a standalone server or another type of computing device. The capacity management system 115 may perform one or more operations and/or processes described in more detail elsewhere herein.

The network 220 may include one or more wired and/or wireless networks. For example, the network 220 may include a cellular network (e.g., a 5G network, a 4G network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the FWA device 105, the base station 110, and/or the capacity management system 115. In some implementations, the FWA device 105, the base station 110, and/or the capacity management system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

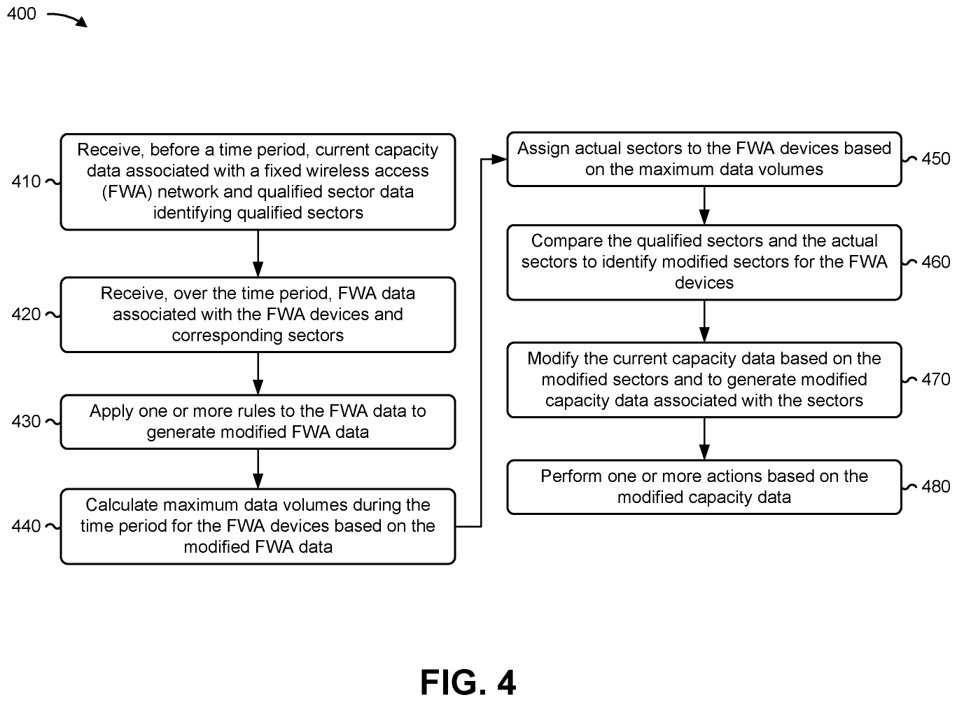

FIG. 4 is a flowchart of an example process 400 for managing capacity of an FWA broadband network. In some implementations, one or more process blocks of FIG. 4 may be performed by a device (e.g., the capacity management system 115). In some implementations, one or more process blocks of FIG. 4 may be performed by another device or a group of devices separate from or including the device, such as an FWA device (e.g., the FWA device 105) and/or a base station (e.g., the base station 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, before a time period, current capacity data associated with an FWA network and qualified sector data identifying qualified sectors (block 410). For example, the device may receive, before a time period, current capacity data associated with sectors of an FWA network and qualified sector data identifying qualified sectors of FWA devices associated with the FWA network, as described above. In some implementations, the time period is at least thirty days. In some implementations, the current capacity data identifies available capacities of the sectors before the time period.

As further shown in FIG. 4, process 400 may include receiving, over the time period, FWA data associated with the FWA devices and corresponding sectors (block 420). For example, the device may receive, over the time period, FWA data associated with the FWA devices and corresponding sectors, as described above.

As further shown in FIG. 4, process 400 may include applying one or more rules to the FWA data to generate modified FWA data (block 430). For example, the device may apply one or more rules to the FWA data to generate modified FWA data, as described above. In some implementations, applying the one or more rules to the FWA data to generate the modified FWA data includes one or more of applying one or more exclusion rules that exclude data from the FWA data, applying a rule that combines the FWA data for each of the sectors, or applying one or more network rules that modify a current capacity associated with the FWA data.

As further shown in FIG. 4, process 400 may include calculating maximum data volumes during the time period for the FWA devices based on the modified FWA data (block 440). For example, the device may calculate maximum data volumes during the time period for the FWA devices based on the modified FWA data, as described above.

As further shown in FIG. 4, process 400 may include assigning actual sectors to the FWA devices based on the maximum data volumes (block 450). For example, the device may assign actual sectors to the FWA devices based on the maximum data volumes, as described above.

As further shown in FIG. 4, process 400 may include comparing the qualified sectors and the actual sectors to identify modified sectors for the FWA devices (block 460). For example, the device may compare the qualified sectors and the actual sectors to identify modified sectors for the FWA devices, as described above. In some implementations, comparing the qualified sectors and the actual sectors to identify the modified sectors for the FWA devices includes determining that one of the qualified sectors fails to match a corresponding one of the actual sectors, and identifying, as one of the modified sectors, the corresponding one of the actual sectors instead of the one of the qualified sectors. In some implementations, comparing the qualified sectors and the actual sectors to identify the modified sectors for the FWA devices includes determining that one of the qualified sectors matches a corresponding one of the actual sectors, and maintaining, as one of the modified sectors, the one of the qualified sectors.

As further shown in FIG. 4, process 400 may include modifying the current capacity data based on the modified sectors and to generate modified capacity data associated with the sectors (block 470). For example, the device may modify the current capacity data based on the modified sectors and to generate modified capacity data associated with the sectors, as described above. In some implementations, the modified capacity data identifies available capacities of the sectors after the time period.

As further shown in FIG. 4, process 400 may include performing one or more actions based on the modified capacity data (block 480). For example, the device may perform one or more actions based on the modified capacity data, as described above. In some implementations, performing the one or more actions includes identifying a base station associated with one of the sectors that is affected by the modified capacity data, and optimizing the base station based on the modified capacity data. In some implementations, optimizing the base station based on the modified capacity data includes one or more of modifying a tilt of the base station based on the modified capacity data, modifying an azimuth of the base station based on the modified capacity data, or adding additional spectrum to the base station based on the modified capacity data.

In some implementations, performing the one or more actions includes identifying one or more of the sectors that are affected by the modified capacity data, and providing additional equipment for the one or more of the sectors based on the modified capacity data. In some implementations, performing the one or more actions includes identifying one or more of the sectors that are affected by the modified capacity data, and modifying a sales strategy for the one or more of the sectors based on the modified capacity data.

In some implementations, performing the one or more actions includes identifying one of the sectors that is affected by the modified capacity data, and causing one or more base stations to be provided in the one of the sectors. In some implementations, performing the one or more actions includes identifying one or more capacity depletion triggers for one or more of the sectors that are affected by the modified capacity data, and modifying the one or more capacity depletion triggers for the one or more of the sectors based on the modified capacity data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and before a time period, current capacity data associated with sectors of a fixed wireless access (FWA) network and qualified sector data identifying qualified sectors of FWA devices associated with the FWA network;
receiving, by the device and over the time period, FWA data associated with the FWA devices and corresponding sectors;
applying, by the device, one or more rules to the FWA data to generate modified FWA data;
calculating, by the device, maximum data volumes during the time period for the FWA devices based on the modified FWA data;
assigning, by the device, actual sectors to the FWA devices based on the maximum data volumes;
comparing, by the device, the qualified sectors and the actual sectors to identify modified sectors for the FWA devices;
modifying, by the device, the current capacity data based on the modified sectors and to generate modified capacity data associated with the sectors; and
performing, by the device, one or more actions based on the modified capacity data.

2. The method of claim 1, wherein the time period is at least thirty days.

3. The method of claim 1, wherein applying the one or more rules to the FWA data to generate the modified FWA data comprises one or more of:
applying one or more exclusion rules that exclude data from the FWA data;
applying a rule that combines the FWA data for each of the sectors; or
applying one or more network rules that modify a current capacity associated with the FWA data.

4. The method of claim 1, wherein comparing the qualified sectors and the actual sectors to identify the modified sectors for the FWA devices comprises:
determining that one of the qualified sectors fails to match a corresponding one of the actual sectors; and
identifying, as one of the modified sectors, the corresponding one of the actual sectors instead of the one of the qualified sectors.

5. The method of claim 1, wherein comparing the qualified sectors and the actual sectors to identify the modified sectors for the FWA devices comprises:
determining that one of the qualified sectors matches a corresponding one of the actual sectors; and
maintaining, as one of the modified sectors, the one of the qualified sectors.

6. The method of claim 1, wherein the current capacity data identifies available capacities of the sectors before the time period.

7. The method of claim 1, wherein the modified capacity data identifies available capacities of the sectors after the time period.

8. A device, comprising:
one or more processors configured to:
receive, before a time period, current capacity data associated with sectors of a fixed wireless access (FWA) network and qualified sector data identifying qualified sectors of FWA devices associated with the FWA network,
wherein the current capacity data identifies available capacities of the sectors before the time period;
receive, over the time period, FWA data associated with the FWA devices and corresponding sectors;
apply one or more rules to the FWA data to generate modified FWA data;
calculate maximum data volumes during the time period for the FWA devices based on the modified FWA data;
assign actual sectors to the FWA devices based on the maximum data volumes;
compare the qualified sectors and the actual sectors to identify modified sectors for the FWA devices;
modify the current capacity data based on the modified sectors and to generate modified capacity data associated with the sectors; and
perform one or more actions based on the modified capacity data.

9. The device of claim 8, wherein the one or more processors, to perform the one or more actions, are configured to:
identify a base station associated with one of the sectors that is affected by the modified capacity data; and
optimize the base station based on the modified capacity data.

10. The device of claim 9, wherein the one or more processors, to optimize the base station based on the modified capacity data, are configured to one or more of:
modify a tilt of the base station based on the modified capacity data;
modify an azimuth of the base station based on the modified capacity data; or
add additional spectrum to the base station based on the modified capacity data.

11. The device of claim 8, wherein the one or more processors, to perform the one or more actions, are configured to:
identify one or more of the sectors that are affected by the modified capacity data; and
provide additional equipment for the one or more of the sectors based on the modified capacity data.

12. The device of claim 8, wherein the one or more processors, to perform the one or more actions, are configured to:
identify one or more of the sectors that are affected by the modified capacity data; and
modify a sales strategy for the one or more of the sectors based on the modified capacity data.

13. The device of claim 8, wherein the one or more processors, to perform the one or more actions, are configured to:
identify one of the sectors that is affected by the modified capacity data; and
cause one or more base stations to be provided in the one of the sectors.

14. The device of claim 8, wherein the one or more processors, to perform the one or more actions, are configured to:
identify one or more capacity depletion triggers for one or more of the sectors that are affected by the modified capacity data; and
modify the one or more capacity depletion triggers for the one or more of the sectors based on the modified capacity data.

15. A non-transitory computer-readable medium storing a set of instructions, the set of instructions comprising:
one or more instructions that, when executed by one or more processors of a device, cause the device to:
receive, before a time period, current capacity data associated with sectors of a fixed wireless access (FWA) network and qualified sector data identifying qualified sectors of FWA devices associated with the FWA network;
receive, over the time period, FWA data associated with the FWA devices and corresponding sectors;
apply one or more rules to the FWA data to generate modified FWA data;
calculate maximum data volumes during the time period for the FWA devices based on the modified FWA data;
assign actual sectors to the FWA devices based on the maximum data volumes;
compare the qualified sectors and the actual sectors to identify modified sectors for the FWA devices;
modify the current capacity data based on the modified sectors and to generate modified capacity data associated with the sectors,
wherein the modified capacity data identifies available capacities of the sectors after the time period; and
perform one or more actions based on the modified capacity data.

16. The non-transitory computer-readable medium of claim 15, wherein the one or more instructions, that cause the device to apply the one or more rules to the FWA data to generate the modified FWA data, cause the device to one or more of:
apply one or more exclusion rules that exclude data from the FWA data;
apply a rule that combines the FWA data for each of the sectors; or
apply one or more network rules that modify a current capacity associated with the FWA data.

17. The non-transitory computer-readable medium of claim 15, wherein the one or more instructions, that cause the device to compare the qualified sectors and the actual sectors to identify the modified sectors for the FWA devices, cause the device to:
determine that one of the qualified sectors fails to match a corresponding one of the actual sectors; and
identify, as one of the modified sectors, the corresponding one of the actual sectors instead of the one of the qualified sectors.

18. The non-transitory computer-readable medium of claim 15, wherein the one or more instructions, that cause the device to compare the qualified sectors and the actual sectors to identify the modified sectors for the FWA devices, cause the device to:
determine that one of the qualified sectors matches a corresponding one of the actual sectors; and
maintain, as one of the modified sectors, the one of the qualified sectors.

19. The non-transitory computer-readable medium of claim 15, wherein the one or more instructions, that cause the device to perform the one or more actions, cause the device to:
identify a base station associated with one of the sectors that is affected by the modified capacity data; and
optimize the base station based on the modified capacity data.

20. The non-transitory computer-readable medium of claim 15, wherein the one or more instructions, that cause the device to perform the one or more actions, cause the device to:
identify one or more of the sectors that are affected by the modified capacity data; and
provide additional equipment for the one or more of the sectors based on the modified capacity data.
